(19) United States
(12) Patent Application Publication
(10) Pub. No.: US 2003/0034649 A1
(43) Pub. Date: Feb. 20, 2003

(54) Universal conduit body and system

(76) Inventors: Greg D. Gault, Ashland, OH (US); James R. Streng, Ashland, OH (US)

Correspondence Address: CALFEE HALTER & GRISWOLD, LLP, 800 SUPERIOR AVENUE, SUITE 1400, CLEVELAND, OH, 44114, US

(21) Appl. No.: 10/274,214

(22) Filed: Oct. 18, 2002

Related U.S. Application Data
(63) Continuation-in-part of application No. 09/891,831, filed on Jun. 26, 2001.

(51) Int. Cl. F16L 51/00

(52) U.S. Cl. 285/125.1

(57) ABSTRACT

A universal conduit body system is provided having an outer housing having a first wall thickness, at least one port and an inner space. Each port has an opening in the housing and a recess in the housing surrounding the opening. Each recess includes a second wall thickness less than the first wall thickness. In use, the port mates with a connector that includes an interface or base having substantially the same physical shape as the recess.

### CROSS-REFERENCE TO RELATED APPLICATIONS

This patent application is a continuation-in-part of pending U.S. patent application Ser. No. 09/891,831, filed Jun. 26, 2001, and titled “Universal Conduit Body and System.”

### FIELD OF THE INVENTION

The invention relates generally to electrical system wiring and, more particularly, to a universal conduit body and system that can be assembled into a wide variety of different configurations to meet the specific needs of an installation.

### BACKGROUND OF THE INVENTION

In residential, commercial, and industrial electrical installations, a system comprising of runs of conduit is employed for the distribution of electrical wiring throughout the premises. A “conduit” is a metal or plastic pipe or tubing utilized for the purpose of carrying insulated electrical wires. As such, conduits provide a convenient and effective way to: (1) gather electrical wires or conductors together, (2) make wiring connections, (3) protect the wires from damage or wear from the elements and against mechanical disturbances, and (4) provide a pathway from an electrical distribution panel, for example, to the various locations of electrical fixtures, equipment, machinery, appliances, and receptacles as may be desired throughout the premises. These insulated wires are designed to carry relatively high voltages and currents (carrying 0 up to 2000 volts and 0 up to 750 amps). Conduit is also widely used to contain optic fibers and/or signal or control wire (i.e., wire operating at a lower voltage with a maximum of 110 volts down to millivolts, serving to actuate switches and thermostats, or, in the case of telephone and data, wire for communications and computers).

Conduit systems themselves include more than just metal or plastic conduits. They also include conduit bodies, fittings, couplings, and other similar devices that are used as interconnection mechanisms between individual conduits or conduit systems. For example, conduit bodies enable sharp changes in direction to be made in a conduit run and, in this regard, are to be contrasted with elbows, which are bent portions of conduit. Additionally, conduit bodies can be coupled to straight conduit runs by suitable connectors. Tubular conduits typically attach to conduit bodies by means of connectors.

One drawback of prior conduit bodies is that they have evolved into, a wide variety of sizes and configurations. In this regard, an electrician or other user must have available a wide variety of different conduit bodies for a particular job. Standard conduit bodies are coded ST, LB, LL, LR, and T. The ST configuration is provided as a straight through conduit body used to aid the electrician in pulling wires in a long run. The LB configuration provides a right angle turn along the length of the conduit body extending oppositely away from the removable cover (through the bottom). The LL configuration provides a right angle turn along the length of the conduit body extending to the left of the removable cover. The LR configuration provides a right angle turn along the length of the conduit body to the right of the removable cover. The T configuration provides two points of connecting conduit at opposite longitudinal ends of the conduit body, and a “tee” connector extending on one or more sides of the conduit body. When using the prior type of conduit body, not only must the electrician carry a sufficient supply of all configurations of these conduit bodies to the job site, but, there must be a variety of conduit bodies for each size of conduit likely to be employed on the job. Thus, for an electrician to be adequately equipped, a very large variety of conduit bodies must be available.

Another drawback of prior conduit bodies is that once they have been installed, subsequent changes in arrangement of the connected conduits, such as the attachment of an additional branch conduit run, has typically required that the conduit body be removed and replaced entirely. This procedure necessitates removal of all existing wires, removal and replacement of the conduit body with a new appropriately configured conduit body, reinstallation of the original wires, and installation of the new wires in the additional run. This procedure is inconvenient, time consuming, and expensive.

Thus, an unsolved need exists for an improved conduit body and system that overcomes the limitations and drawbacks of the prior designs.

### SUMMARY OF THE INVENTION

One objective of the present invention is to provide a universal conduit body that is adaptable by the user at the job site into a virtually unlimited number of differing physical configurations.

Another objective of the present invention is to provide a universal conduit body that is reconfigurable after original installation by the addition or removal of connectors without the need for the removal and replacement of the conduit body or the originally installed electrical wires.

Another objective of the present invention is to provide a conduit body that has a universal body that is fitted on its sides and/or ends with a variety of removable cover plates and wherein each cover plate may be replaced with one or more connectors for attachment to conduits.

In accordance with these objectives, a universal conduit body is provided having an outer housing having a first wall thickness, at least one port and an inner space. Each port has an opening in the housing and a recess in the housing surrounding the opening. Each recess includes a second wall thickness less than the first wall thickness. In use, the port mates with a connector that includes an interface or base having substantially the same physical shape as the recess. A removable port cover plate is provided to close any unused ports. In this regard, the port cover plate can also be manufactured with or molded into the conduit body as “knock-outs.”

Configured as such, the present invention provides the ability, to attach the connector to the conduit first, then once secure on the conduit, the connector can be attached to the conduit body. When using the prior conduit body in tight locations, it could not be rotated to thread the conduit into the connector, the present invention permits the connector to be threaded on to the conduit prior to connecting to the conduit body. This design also permits multiple conduit bodies to be stacked side by side during installation whereby access to the screws or lock nuts securing the connectors to the conduit body would be maintained through the interior of the conduit body.

These and other objectives, aspects, advantages and features of the present invention will be more fully understood and appreciated upon consideration of the following detailed description of the preferred conduit bodies presented in conjunction with the accompanying drawings.

### BRIEF DESCRIPTION OF THE DRAWINGS

In the accompanying drawings which are incorporated in and constitute a part of the specification, embodiments of the invention are illustrated, which, together with a general description of the invention given above, and the detailed description given below, serve to example the principles of this invention.

FIG. 1 is a perspective view of a first system embodiment of the present invention.

FIG. 2 is a perspective view of a second system embodiment of the present invention.

FIGS. 3, 4, and 5 are perspective views of multiple embodiments of a connector of the present invention.

FIGS. 6 through 9 generally illustrate the system of FIG. 1 arranged for LB, LL, LR, and T configurations.

FIG. 10 illustrates the system of FIG. 1 with multiple connectors.

FIG. 11 is a perspective view of a third system embodiment of the present invention.

FIGS. 12-17 illustrate multiple conduit fitting embodiments of the present invention.

### DETAILED DESCRIPTION OF ILLUSTRATED EMBODIMENT

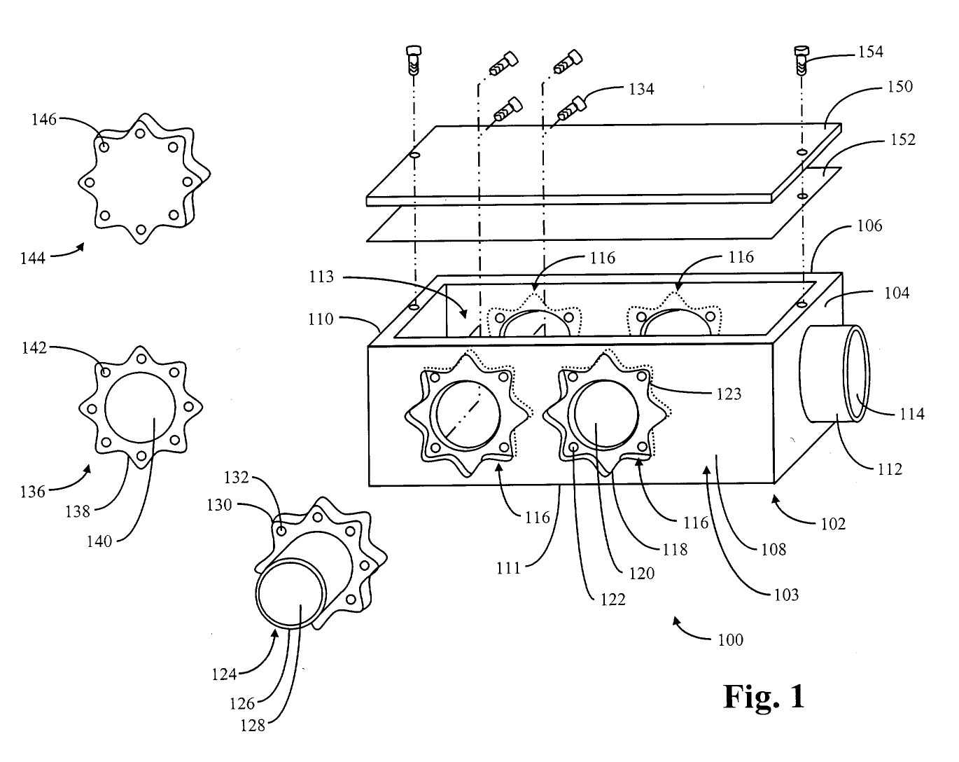

Referring to FIG. 1, a system 100 of the present invention is shown. System 100 has a conduit body 102 with associated cover plate 150 and optional gasket 152, connector or conduit fitting 124, optional port gasket 136, and port cover plate 144. Conduit body 102 is preferably any portion of a conduit or tubing system that provides access through a removable cover(s) to the interior of the system at a junction of two or more sections of the system or at a terminal point of the system—including boxes such as FS and FD or larger cast or sheet metal boxes. As shown in FIG. 1, conduit body 102 has a housing 103 having side walls 104, 106, 108, 110, and 111. The aforementioned side walls cooperate to form a hollow inner space 113. Side wall 104 has a cylindrically-walled stub 112 forming a hollow inner space 114. Stub 112 is used for affixing or other connecting a first conduit to conduit body 102. Spaces 113 and 114 together form a freely communicating unitary hollow space. Of the remaining side walls 106, 108, 110, and 111, each has at least one port 116 for facilitating connection with one or more connectors 124. In the embodiment of FIG. 1, side walls 106 and 108 have two ports 116, side wall 111 has two ports 116 (not shown), and side wall 110 has one port 116 (not shown). All of the ports 116 are of the same construction for a given embodiment.

In this regard, port 116 has an aperture 120 through its respective side wall that is surrounded by a recess or indentation 118 in the side wall. Recess 118 has a shape that includes a number of extensions or projections 123. In the embodiment of FIG. 1, recess 118 has a star shape with eight extensions. In other embodiments employed a star-shaped recess 118, there can be more or less than 8 extensions. In general, the shape of recess 118 can be any shape that proves suitable for the purpose of alignment. For example, the shape of recess 118 can be a polygon having three or more sides or a star-shape with any number of extensions. Additionally, the shape of recess 118 can incorporate curved, orthogonal, or angled extensions. The embodiment of FIG. 1 illustrates a star-shaped recess 118 wherein the extensions are curved.

Each port 116 also has one or more holes 122 for the securing of fasteners such as screws or bolts. Holes 122 are preferably located within the bounds of extensions 123 and extend from the bottom of the recess and on through the remainder of the side wall thickness so as to communicate with inner space 113. The embodiment of FIG. 1 illustrates such holes 122 for each port or one in every other extension 123. Depending on the design, more or less such holes can be provided. For example, each extension 123 can have a hole 122 therein.

Recess 118 surrounds aperture 120 and has a recess depth that is less than the side wall thickness. The actual recess depth or thickness and side wall thickness depend on the type of material from which system 100 and conduit body 102 are made. In this regard, suitable materials for forming system 100 and its components includes metals such as aluminum, steel, or iron, and plastics such as PVC or CPVC.

Connector 124 preferably has a cylindrically-walled stub or shank 126 and an alignment interface or base 130. The cylindrically-walled stub or shank 126 forms an inner hollow space 128. Alignment interface or base 130 is configured to at least partially fit within recess 118. More specifically, alignment interface or base 130 has a shape that corresponds to the shape of recess 118. In the embodiment of FIG. 1, recess 118 has a star-like shape with eight extensions. Alignment interface or base 130 has a corresponding star-like shape also with eight extensions. So configured, alignment interface or base 130 can be at least partially inserted within recess 118 so as to provide proper alignment of connector 124 and restrict the movement of connector 124 when so in place.

In the embodiment of FIG. 1, connector 124 is fastened to conduit body 102 through one or more screws or bolts 134 and holes 132 in the alignment interface or base. In particular, alignment interface or base 130 is used to properly align connector 124′ within recess 118. The shape of alignment interface or base 130 is such that it facilitates the rotating or turning thereof either by hand or tool to arrive at the proper alignment. Once so aligned, screws or bolts 134 are threaded through hole 122 in the recess side wall and holes 132 in the alignment interface or base 130. The embodiment of FIG. 1 shows screws or bolts 134 fastening connector 124 to conduit body 102 via the interior hollow space 113 of conduit body 102. It should be noted that screws or bolts 134 can also be used from the exterior of the conduit body 102 to fasten connector 124. Once attached, inner hollow space 128 cooperates with interior hollow space 113 to form a freely communicating unitary hollow space for running wires or conductors there through.

The port gasket 1,36 is optional and can be placed in between the alignment interface or base 130 and recess 118 to provide an air or water-tight seal. In this regard, the port gasket 136 is configured to fit within recess 118. More specifically, port gasket 136 has an aperture or hole 140 therein and a shape that also corresponds to the shape of recess 118. In the embodiment of FIG. 1, recess 118 has a star-like shape with eight extensions. Hence, port gasket 136 also has a star-like shape with eight extensions. Holes 142 are provided in port gasket 136 that properly align with holes 132 in the alignment interface or base 130 and holes 122 in the recess side wall. Port gasket 136 can be made of any conventional gasket material 138 such as, for example, silicon or rubber. In the alternative, port gasket 136 can be a conventional o-ring appropriately sized to seal recess 118.

The port cover plate 144 is utilized for covering any exposed ports 116 that are not in use. In this regard, port cover plate 144 also has a shape that corresponds to the shape of recess 118. As described above, shape of recess 118 in FIG. 1 is that of a star with eight extensions. Therefore, the shape of port cover plate 144 is also that of a star with eight extensions. Port cover plate 144 also includes therein holes 146 for alignment with holes 122 in the recess side wall. Screws or bolts or lock nuts are used to attach port cover plate 144 to conduit body 102 in the same manner as that of connector 124. Port cover plate 144 is preferably made of the same material as system 100.

Conduit body cover plate 150 and optional gasket 152 are provided to close conduit body 102 when installation is complete. Conduit body cover plate 150 and gasket 152 have holes therein for screws or bolts that are used to fasten the cover plate 150 and gasket 152 to conduit body 102. Gasket 152 can also be in the conventional form of an o-ring or gasket ring.

In operation, a rigid wire carrying body such as, for example, a conduit, is affixed to cylindrically-walled stub or shank 126 of connector 124. Once affixed, the alignment interface or base 130 of connector 124 is used to align connector 124 with recess 118 in conduit body 102. In this regard, since both the recess 118 and alignment interface or base 130 are star-shaped with eight extensions, no more than an eighth of a turn of connector 124 is required for proper alignment. Hence, this eight point shape allows multiple connection points throughout the rotation of the connector 124. It should now also be evident as to the effect of providing more or less than eight points of connection.

In this regard, the present invention provides for the ability to attach connector 124 to a conduit first, then once secure on the conduit, connector 124 can be attached to conduit body 102 by means of screws 134 that pass through the conduit body 102 recess side wall holes 122 into threaded screw holes or openings 132 in alignment interface or base 130. Holes 122 can also be threaded if desired. When using the prior conduit body in tight locations, it could not be rotated to thread the conduit into the connector. The present invention permits connector 124 to be threaded or otherwise affixed to the conduit prior to connecting to conduit body 102. This design also permits multiple conduit bodies to be stacked side by side during installation whereby access to the screws securing the connectors to the conduit body would be maintained through the interior of the conduit body.

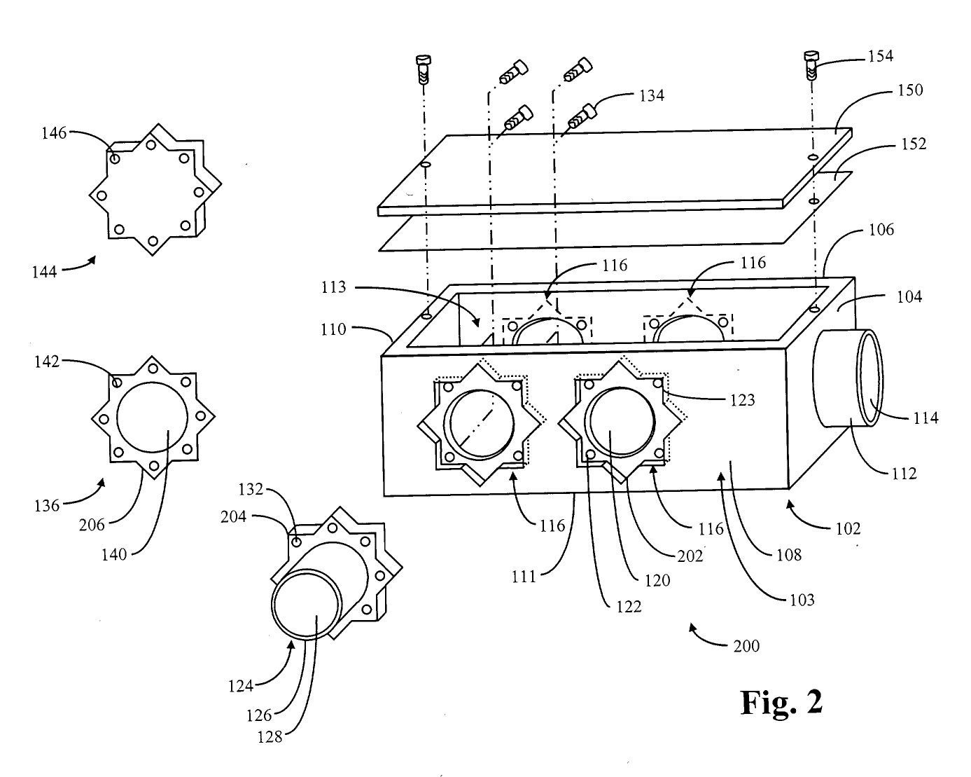

Referring now to FIG. 2, a second system 200 is illustrated. System 200 is identical to system 100, except for the shape of the recesses, alignment interface, port gasket and port cover plate. In this regard, system 200 incorporates a polygon-shaped recess 202. The polygon shape is in the form of an octagon, or eight-sided figure. As described above, more or less than eight-sided polygons can also be used. In accord therewith, connector 124 also includes an alignment interface or base 204 having polygon shape that is also eight-sided. Similarly, port gasket 136 also includes a polygon shape 206 that is eight-sided, as also does port cover plate 144. Otherwise, systems 100 and 200 offer the same operation, advantages, and benefits.

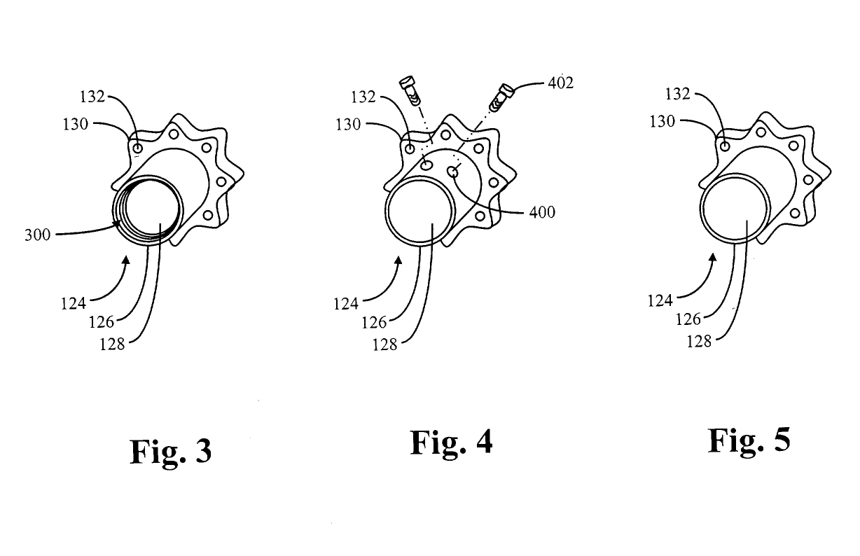

Illustrated in FIGS. 3, 4, and 5 are various embodiments of connector 124. The embodiments vary according to the material from which system 100 and it components are made. Referring now to FIG. 3, connector 124 is shown having threads on the interior of cylindrically-walled stub or shank 126. This configuration is preferred for when system 100 and its components are manufactured from metals such as iron, steel, or aluminum. In such a case, a conduit having corresponding threads is threaded to stub or shank 126 via threads 300.

Referring now to FIG. 4, connector 124 is shown having threaded holes 400 and set screws 402. Holes 400 extend through cylindrically-walled stub or shank 126 and freely communicate with inner space 128. This configuration is preferred for when system 100 and its components are made from cast aluminum. In such a case, a conduit is inserted into stub or shank 126 and affixed thereto via set screws 402. It should be appreciated that the number and location of holes 400 and set screws 402 can be varied.

Referring now to FIG. 5, connector 124 is shown with a smoothly walled cylindrical stub or shank 126. This configuration is preferred for when system 100 and its components are made from a plastic material. In such a case, a conduit is cemented or otherwise bonded with a bonding material to the inner wall of stub or shank 126.

It should also be noted that in all embodiments, stub or shank 126 can have configurations other than cylindrically-walled. For example, stub or shank 126 can be polygonal in nature wherein it has more or less than eight sides (i.e., octagonal). Such a configuration is advantageous for gripping such as when pliers are used to turn, rotate, or otherwise hold connector 124. Alternatively, stub or shank 126 can be cylindrically-walled with longitudinal projections extending from and running along the outer cylinder wall. Such a configuration would, once again, provide an advantage when gripping connector 124 when using pliers to turn, rotate, or otherwise hold connector 124. Stub 112 of conduit body 102 can incorporate these same configurations, including those illustrated for stub or shank 126 in FIGS. 3, 4, and 5. Preferably, stubs or shanks 112 and 126 have the same physical configuration, though that is not always necessary.

Moreover, stub or shank 126 and alignment interface or base 130 can be integrally manufactured or separately manufactured and fastened together. Integral manufacturing, can take the form of machining and casting metals and plastics. Separate manufacture can take the form of machining and/or casting each portion individually and fastening them together. The fastening can be provided via threads integral to each component or bonding surfaces for cementing or welding each component together. Hence, connector 124 can be manufactured via a plurality of methods. Conduit body 102 can be similarly manufactured with respect to its housing 103 and stub 112.

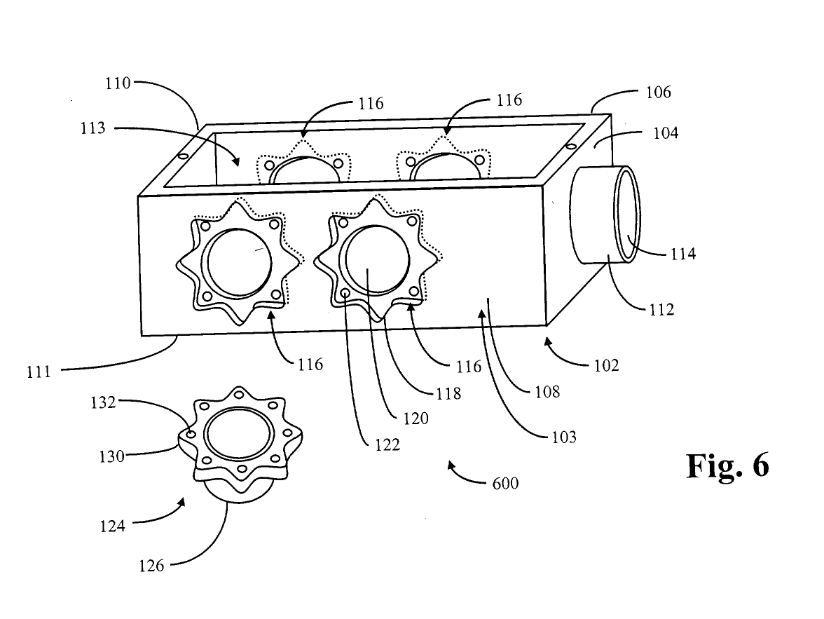

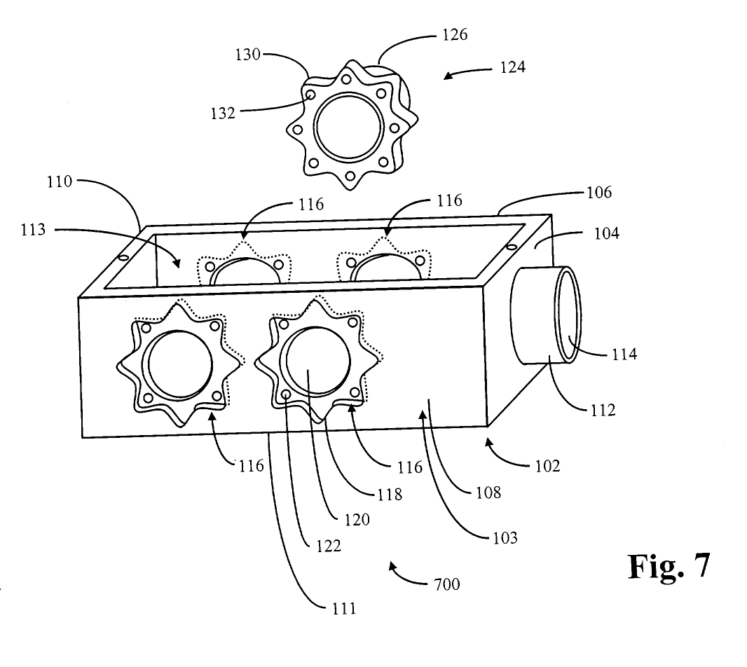

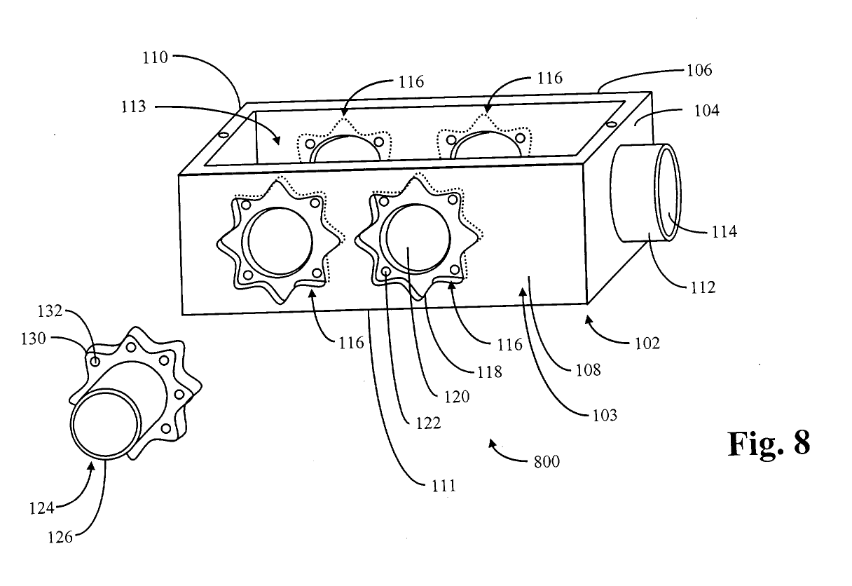

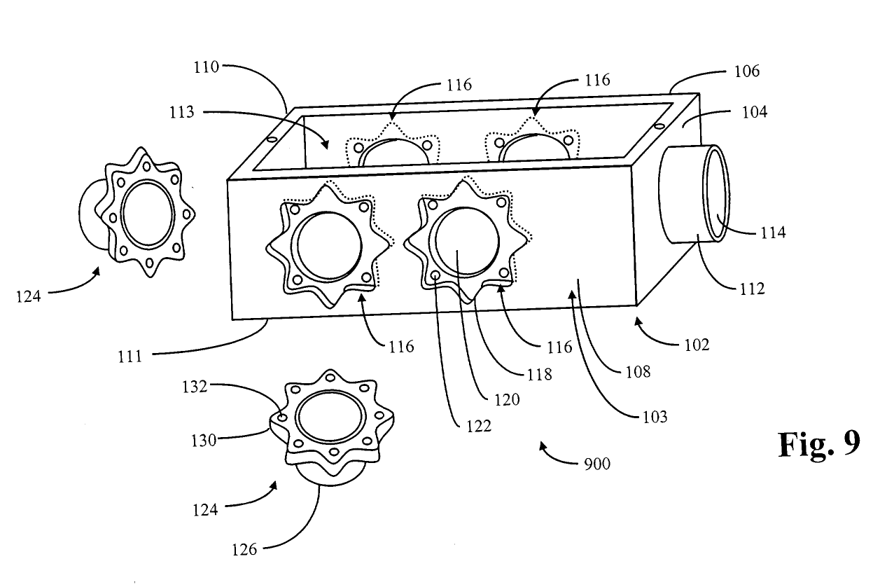

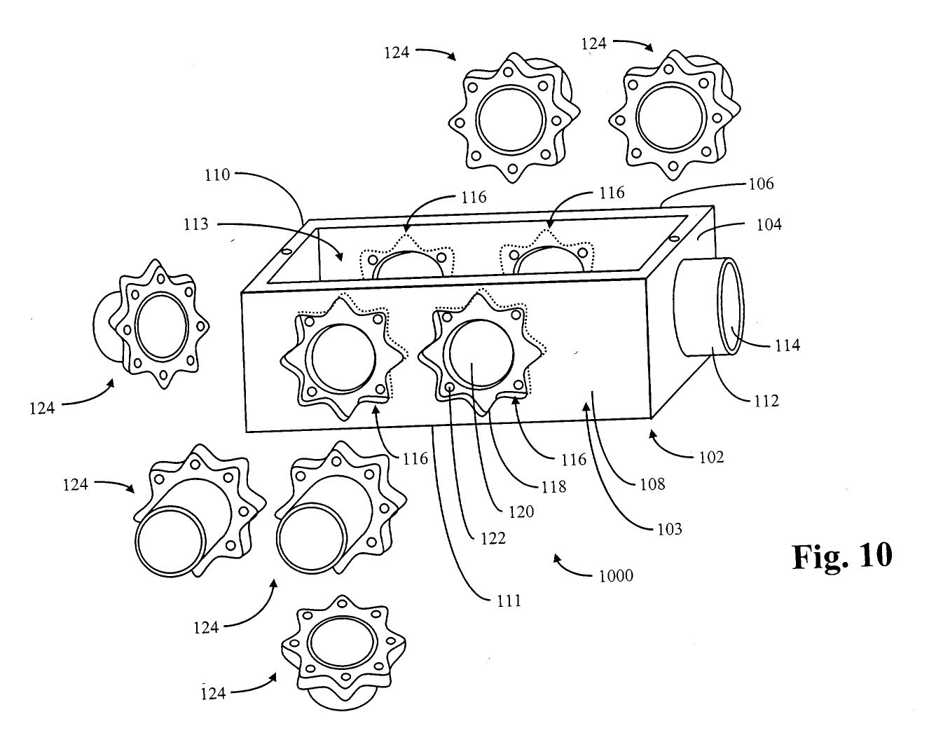

FIGS. 6 through 10 illustrate the present invention arranged in various industry configurations. In these figures, cover plate 150, optional gaskets 136 and 152, and screws or bolts 134 and 154 are not illustrated for purposes of clarity. However, it should be understood that as described above these components can also form part of the arrangements shown. In this regard, FIG. 6 illustrates the present invention in the LB configuration shown generally at 600. In this configuration, connector 124 is aligned and affixed to port 116 in bottom side wall 111 of the conduit body. FIG. 7 illustrates the present invention in the LL configuration shown generally at 700. In this configuration, connector 124 aligns and affixes to port 116 in side wall 106. FIG. 8 illustrates the present invention in the LR configuration shown generally at 800. In this configuration, connector 124 aligns and affixes to port 116 in side wall 108. FIG. 9 illustrates the present invention in the T configuration shown generally at 900. In this configuration, two connectors 124 are used. A first connector 124 aligns and affixes to port 116 in bottom side wall 111 and a second connector 124 aligns and affixes to port 116 in side wall 110. FIG. 10 illustrates configuration 1000 with multiple connectors 124 and ports 116. In all of the aforementioned embodiments, port cover plates 144 are used to seal unused ports 116 in the side walls.

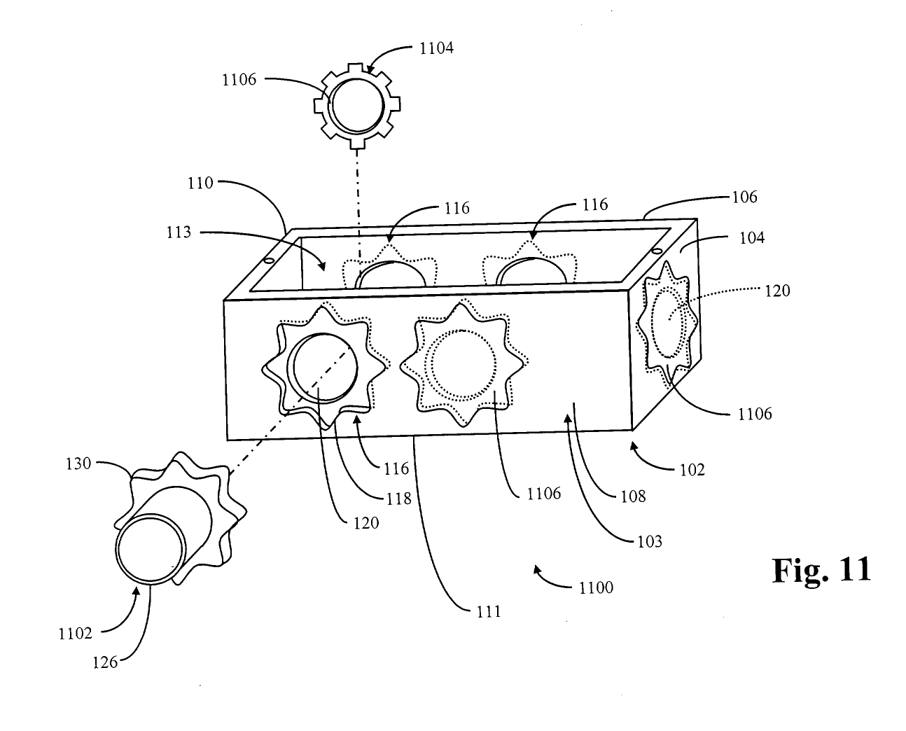

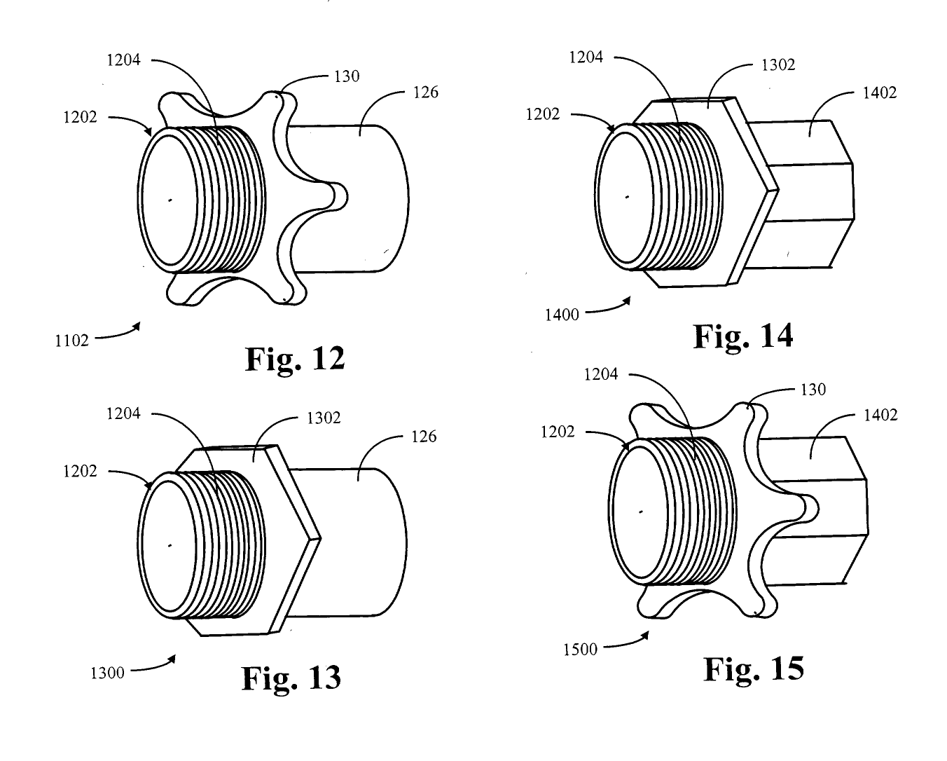

Referring now to FIGS. 11 and 12, a third system embodiment 1100 of the present invention is shown. System 1100 is identical to system 100 of FIG. 1, except that connector 124 has been replaced by connector or conduit fitting 1102 and fasteners 134 have been replaced by a lock nut 1104. As shown in more detail in FIG. 12, conduit fitting 1102 includes alignment interface or base 130, a first stub or shank 1202 and second stub or shank 126. It can be seen that conduit fitting 1102 of FIG. 12 differs from conduit fitting 124 in that conduit fitting 124 does not have stub or shank 1202. Stub or shank 1202 is substantially in the shape of a hollow cylinder and includes threads 1204 on its, outer surface. Stub or shank 126 is configured as previously described. Threads 1204 are used to matingly attach lock nut 1104 to stub or shank 1202. In this regard, lock nut 1104 includes threads 1106 that are configured to mate with threads 1204.

In this embodiment, the conduit body 102 has each port 116 manufactured with removable port “knock-out” cover plates 1106. The port “knock-out” cover plates 1106 seal the conduit body 102 and ports 116 until removed. During installation, an individual can knock-out or remove the port “knock-out” cover plates 1106 as required to gain access to ports 116. In this regard, ports 116 not in use would have their “knock-out” cover plates 1106 remaining in place. As such, the port “knock-out” cover plates 1106 have one or more fractious portions connecting the “knock-out” cover plates 1106 to the conduit body 102. These fractious portions are specifically designed to break or give-away in a manner so as to release the “knock-out” cover plates 1106 from the conduit body 102 so as to not deform or otherwise adversely effect either component. The “knock-out” cover plates 1106 preferably have the same geometry as recess 118, though variations are also possible. The external opening of stub 112 can also be covered by a “knock-out” plate as generally described above.

In operation, conduit fitting 1102 is attached to a rigid wire carrying body such as, for example, a metal conduit, by attaching the rigid wire carrying body to stub or shank 126 as described in association with FIGS. 3, 4, and 5. Once the rigid wire carrying body is attached to the conduit fitting 1102, the alignment interface or base 130 of conduit fitting 1102 is used to align the conduit fitting 1102 with recess 118 in conduit body 102 after the appropriate “knock-out” cover plate 1106 has been removed. In this regard, since both the recess 118 and alignment interface or base 130 are star-shaped with eight extensions, no more than an eighth of a turn of conduit fitting 1102 is required for proper alignment. Hence, this eight point shape allows multiple connection points throughout the rotation of the conduit fitting 124. Once aligned, lock nut 1104 is threaded onto stub or shank 1202 through the inside of conduit body 102 to secure conduit fitting 1102 to conduit body 102.

FIGS. 13-17 illustrate additional embodiments of conduit fittings according to the present invention. FIG. 12 illustrates a conduit fitting 1300 substantially similar to conduit fitting 1102, except that star-shaped alignment interface or base 130 has been substituted with a hexagonal-shaped alignment interface or base 1302. FIG. 14 illustrates a conduit fitting 1400 that is similar to conduit fitting 1300, except that cylindrical stub or shank 126 has been replaced with an octagonal-shaped stub or shank 1402. FIG. 15 illustrates a conduit fitting 1500 that is similar to conduit fitting 1400, except that alignment interface or base 1302 has been substituted with star-shaped alignment interface or base 130.

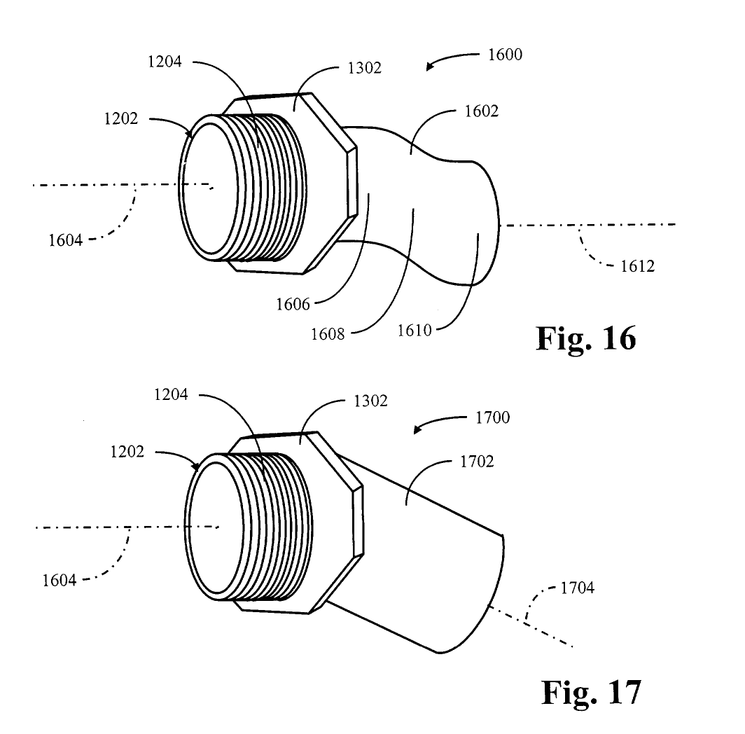

FIG. 16 illustrates a conduit fitting 1600 similar to conduit fitting 1300 except that cylindrical stub or shank 126 has been substituted with an offset stub or shank 1602. In this regard, offset stub or shank 1602 includes at least three portions 1606, 1608, and 1610. Portion 1606 preferably includes a central axis that coincides with central axis 1604 of stub or shank 1202. Portion 1610 includes a central axis 1612 that is offset from the central axis 1604 of stub or shank 1202 and portion 1606. A transition portion 1608 connects portions 1606 and 1610 together. Portions 1606, 1608, and 1610 are all preferably in the form of substantially hollow cylinders. The amount of offset between the axis 1604 and 1612 can be any amount. Offset stub or shank 1602 can be configured according to FIGS. 3, 4, and 5 for attachment to rigid wire carrying bodies. The advantage of providing an offset stub or shank 1602 is that installation space requirements may prohibit the use a substantially cylindrical stub or shank as shown in FIG. 13.

FIG. 17 illustrates a conduit fitting 1700 substantially similar to conduit fitting 1300, except that stub or shank 126 has been substituted with angled stub or shank 1702. In this regard, angled stub or shank 1702 has a central axis 1704 that angled some value away from the central axis 1604. As shown in FIG. 17, central axis is angled approximately 45 degrees away from central axis 1604. Other suitable angles include, for example, 30 degrees, 60 degrees, and any other angle less than or equal to 90 degrees. Stub or shank 1702 can be configured according to FIGS. 3, 4, and 5 for attachment to rigid wire carrying bodies. The advantage provided by angled stub or shank 1702 is that the orientation of certain rigid wire carrying bodies may not allow for a coaxial connection between conduit fitting and the rigid wire carrying body as provided by conduit fittings 124, 1102, 1300, 1400, and 1500.

The systems of the present invention are applicable to conduits for carrying power cable or wire, signal wire or cable and fiber optic cable. The materials and arrangement of the present invention provide for use in above ground and below ground vault installations. Connectors connect to conduits typically by threads (in the case of IMC, HW conduit); via a smooth shank with set screws (in the case of Electrical Metallic Tubing (EMT) or thin wall conduit) or via a smooth shank which may be bonded (in the case of PVC or plastic conduit).

The conduit bodies 102 and other system components can be formed by castings of malleable iron or aluminum, or moldings of suitable plastic material such as polyvinyl chloride (PVC) . As described above, the present invention provides for connectors or conduit fittings that are 1) threaded with inside female tapered threads to mate with male tapered threads cut on the end of a conduit (in the case of Intermediate Metal Conduit (IMC) or HW conduit); 2) smooth with set screws that tightly hold a conduit in place (in the case of EMT or thin wall conduit); or 3) smooth for bonding a conduit permanently in place (in the case of PVC or plastic conduit). The tapered threads of IMC or HW conduit cause a conduit and the conduit fitting to become securely engaged and be held firmly in place. When using EMT or thin wall conduit, the conduit fitting need not be threaded, but have the inside diameter of stub or shank 126 approximately equivalent to the outside diameter of the conduit. Then, by using set screws, the conduit is held firmly in place. Where plastic conduit is to be utilized, the conduit body 102 can likewise be plastic and the conduit fittings need not be threaded but rather may have a stub or shank inside diameter approximately equivalent to the outside diameter of the conduit to facilitate mating and attachment via solvent bonding or other adhesive techniques.

The present invention also provides the capability of using combinations of conduit fittings of different sizes with a given conduit body. For example, a 2 inch conduit body can be fitted with combinations of differently sized conduit fittings such as, for example, a 2 inch connector, 1 ½ inch connector, 1 inch connector, ¾ inch connector, etc. defining either the inner or outer diameter of stub or shank 126, 1402, 1602, or 1702. The size of the connector is typically defined by the size of conduit to be attached to the conduit fitting's stub or shank portion. Such a feature is highly advantageous because it provides for the addition of a conduit fitting or connector to a larger conduit body at a later date with a minimum of effort and provides flexibility in selecting an appropriately sized conduit.

While the present invention has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. For example, the shape of the recess 118 and alignment interface or base 130 can be any shape which suitably assists in aligning connector 124 with port 116. Additionally, it should be readily apparent that the present invention is applicable to junction boxes, pull boxes, device boxes, switch boxes, and any other types of electrical connectors or enclosures including explosion proof and weatherproof boxes and connectors. Moreover, it should also be readily apparent that the present invention can be manufactured according to industry types including JB, JL, JAL, GS, SHE, RS, WB, WE, GE, FS, FD, etc. system components. Therefore, the invention, in its broader aspects, is not limited to the specific details, the representative apparatus, and illustrative examples shown and described. Accordingly, departures can be made from such details without departing from the spirit or scope of the applicant's general inventive concept.

We claim

1. A conduit fitting comprising:
an alignment base, the alignment base having first and second sides;
a first shank extending from the first side of the base, the first shank comprising an exterior surface having a plurality of threads configured for accepting a lock nut; and
a second shank extending from the second surface of the base, the second shank configured for physical attachment to a rigid wire carrying body.

2. The conduit fitting of claim 1 wherein the base comprises a third surface having alternating high and low portions wherein the high and low portions are configured so as to provide a plurality of saddle-shape depressions along the third surface.

3. The conduit fitting of claim 2 wherein the saddle-shape depressions are configured to at least partially cradle the fingers of a user to that a user can turn the conduit fitting without the use of tools.

4. The conduit fitting of claim 1 wherein the second shank configured for physical attachment to a rigid wire carrying body comprises an exterior and an interior surface and wherein the interior surface comprises a plurality of threads.

5. The conduit fitting of claim 1 wherein the second shank configured for physical attachment to a rigid wire carrying body comprises an exterior and an interior surface and at least one threaded aperture extending between the exterior and interior surfaces and is configured to accept a fastener.

6. The conduit fitting of claim 1 wherein the second shank configured for physical attachment to a rigid wire carrying body comprises an exterior and an interior surface and wherein the exterior and interior surface are threadless.

7. The conduit body of claim 1 wherein the second shank configured for physical attachment to a rigid wire carrying body comprises a central axis that is substantially perpendicular to the second side of the alignment base.

8. The conduit body of claim 1 wherein the second shank configured for physical attachment to a rigid wire carrying body comprises a central axis forming a 45 degree angle with the second side of the alignment base.

9. The conduit body of claim 1 wherein the second shank configured for physical attachment to a rigid wire carrying body comprises a central axis forming an angle with the second side of the alignment base that is less than 90 degrees.

10. The conduit body of claim 1 wherein the first shank comprises a first central axis and the second shank configured for physical attachment to a rigid wire carrying body comprises a second central axis and wherein the first central axis is offset from the second central axis.
